(19) United States
(12) Patent Application Publication
(10) Pub. No.: US 2014/0076595 A1
(43) Pub. Date: Mar. 20, 2014

(54) TOOLS

(71) Applicants: Maxwell Derek BELSEY, Auckland (NZ); Terry John GRAY, Auckland (NZ)

(72) Inventors: Maxwell Derek BELSEY, Auckland (NZ); Terry John GRAY, Auckland (NZ)

(21) Appl. No.: 14/090,622

(22) Filed: Nov. 26, 2013

Related U.S. Application Data
(63) Continuation of application No. 13/062,626, filed on Mar. 7, 2011.

(30) Foreign Application Priority Data
Sep. 5, 2008 (NZ) 571026

(51) Int. Cl. A01B 1/00

(52) U.S. Cl. CPC A01B 1/00
USPC 172/371

(57) ABSTRACT

This invention relates to an impact tool. The impact tool includes a handle, and the handle includes a hollow portion. The impact tool also includes an impact portion for impacting with a surface or object, with the impact portion being located at one or both ends of the handle. The impact tool further includes a moveable material, which may be housed within the hollow portion of the handle. The moveable material is adapted or able to move along the hollow portion of the handle during use of the impact tool. The moveable material may serve to increase the momentum associated with the use of the impact tool and/or to reduce the jarring effect associated with the use of the impact tool.

### CROSS REFERENCE TO RELATED APPLICATIONS

This application is a continuation of application Ser. No. 13/062,626 filed on Mar. 7, 2011, which is a National Stage of PCT/NZ2009/000185 filed on Sep. 4, 2009, which claims foreign priority to New Zealand Application No. 571026 filed on Sep. 5, 2008. The entire contents of each of the above applications are hereby incorporated by reference.

### FIELD

This invention relates to improvements in relation to tools. The invention may be particularly suitable for use in relation to hand tools which may be used as impact tools, and the invention will therefore predominantly be described in relation to such use.

### BACKGROUND

A major part of the work of a contractor, such as a fencing contractor, is the digging of holes in the ground, for example, for housing fence posts.

In situations where many holes must be dug and/or where the ground is mostly free of any impediments (for example, when building a fence on farmland) a mechanical posthole borer may be utilised to dig the holes. An advantage of a posthole borer is that it can dig holes reasonably quickly and evenly. However, disadvantages or limitations associated with the use of posthole borers include the following:
1. They are less effective, and also potentially dangerous, when digging holes in ground that has obstacles or impediments such as tree roots, stones, rocks, concrete, scoria, reinforcing mesh, frozen ground, and the like. For example, unexpectedly, hitting a rock could damage the posthole borer and/or injure the person operating it.
2. Posthole borers are only able to dig holes of a certain size, that is, holes of the same diameter as the auger. Hence, in situations where different-sized holes must be dug, posthole borers may be ineffective, and some holes may have to be dug by hand. Furthermore, posthole borers often dig holes that are much larger than the size of the posts to be placed in the hole, thus requiring more work to secure the post in place (for example, by concreting or by adding and/or compacting soil around the post).
3. Posthole borers are heavy and cumbersome, and therefore difficult to transport. Furthermore, they may be ineffective when digging holes in confined spaces, for example, next to a wall.
4. The cost of purchasing and/or hiring and/or running a posthole borer may be prohibitive.

As a result of the above disadvantages, many fencing contractors (and especially those primarily working on domestic house sites) do not use posthole borers, and instead utilise hand tools for digging holes.

The hand tools most commonly utilised for digging holes are garden spades, trenching spades and/or scissor spades. However, spades have limitations when digging in ground that has impediments such as tree roots, which is a very common occurrence when working on house sites. An axe may be utilised to attempt to break through tree roots, however there is not usually enough room to properly swing the axe. In such circumstances, the hole may have to be expanded just to allow for the swing of an axe. This is time consuming, and therefore costly in situations where a contractor has quoted a fixed price for a job.

Spades (and axes) also have limitations when digging in ground that has obstacles such as stones, rocks, concrete, scoria, reinforcing mesh, or even just particularly hard ground, or ground that has a high clay content. In such digging situations the time taken to dig a hole may be substantial, which again may be costly in situations where a contractor has quoted a fixed price for a job. Furthermore, in order to clear the impediments and dig the hole, the contractor may misuse tools, that is, by using them in a style or manner that they were not designed for. For example: a spade may be used like an axe; an axe may be used as a crowbar or ram; a sabre saw may be inserted in the hole to attempt to cut a tree root covered by soil, and so on. Such misuse of tools may result in injury to the user and/or damage to the tools.

Moreover, when digging holes by hand, there is always the possibility of injury or jarring to the contractor, for example when he/she unexpectedly hits a tree root or rock with a spade.

It may therefore be advantageous if there was a hand tool available which essentially combined the attributes of a spade and an axe (and/or a ram or sledgehammer). Such a tool may, for example, expedite the manual digging of holes—and especially in ground with the type of impediments described above.

The use of any hand held impact tool over time tends to tire the user, both through the general exertion associated with using the tool, and also through the user being subjected to the jarring forces associated with repeated impacts of the tool. Examples of such impact tools include spades, axes, sledge hammers, and hand held rams and compacters.

It may therefore be advantageous if there was available a hand held impact tool which included a means for reducing or dampening the jarring forces associated with normal use of the tool and/or which minimised discomfort (or the chances of injury) to the user.

The effectiveness of an impact tool depends to a large extent on its momentum during use, that is, the sum of its mass times velocity. In general terms, the greater the mass of the tool and/or the greater the velocity of the tool during use, then the greater the momentum of the tool, and hence the greater the amount of work that is done by the tool.

It may therefore also be of advantage if there was available a means to increase the momentum that can be applied to a hand held impact tool during its use. That is, the more momentum that can be applied during use of the impact tool, the more efficient and effective the tool becomes, and hence the shorter the time taken to complete a job.

### Object

It is an object of the present invention to provide a tool which goes some way towards addressing one or more of the aforementioned problems or difficulties, or which at the very least provides the public with a useful choice.

### Definitions

Throughout this specification unless the text requires otherwise, the word ‘comprise’ and variations such as ‘comprising’ or ‘comprises’ will be understood to imply the inclusion of a stated integer or step or group of integers or steps but not the exclusion of any other integer or step or group of integers or steps.

The term “hand tool” (or “tool”) as used throughout this specification relates to any implement which is ordinarily operated by hand and which may be used to perform an action or facilitate an operation.

The term “impact tool”, as used throughout this specification includes any hand tool which is used to impact with a surface or object. Examples include hand tools such as spades, forks, axes, rams, compactors, sledge hammers and hammers, and also sporting tools or clubs such as golf clubs, cricket bats, tennis racquets and baseball bats.

### Statements of Invention

According to one aspect of the present invention, there is provided an impact tool, said impact tool including:
a) a handle, said handle including a hollow portion,
b) an impact portion for impacting with a surface or object, said impact portion being located at one or both ends of said handle,
c) a moveable material housed within said hollow portion of said handle, said moveable material being able to move along said hollow portion of said handle during use of said impact tool.

The impact tool may be any type of tool used for impacting a surface or object.

Examples include, but are not limited to, hammers, spades, forks, sledge hammers, hand held compactors, ramming tools, steel bars, axes, and so on. The impact tool may also be a sporting club such as a golf club, cricket bat, baseball bat or tennis racquet.

The handle may be of any size, shape or configuration as required or as desired, or as dictated by the intended purpose, or method of use, of the tool.

Preferably the handle may be substantially elongate, and preferably the handle may be able to gripped or held by the user at any point along its length.

Preferably, the handle may be of substantially constant cross section. In such an embodiment, a substantially round or hexagonal cross section may be particularly suitable.

According to another aspect of the present invention, there is provided an impact tool, substantially as described above, wherein the handle may be provided with gripping means to assist a user of the tool to grip and/or use and/or carry the impact tool.

For example, the handle of the impact tool may be provided with a number of scalloped indentations configured to engage with and/or substantially match the fingers or hand of a user. Alternatively, the handle may be provided with a number of raised portions to similarly engage with and/or substantially match the fingers or hand of a user.

Alternatively and/or additionally, the gripping means may be in the form of a non-slip portion. For example, a non-slip sleeve made of rubber or cloth or a synthetic material(s) may be fitted over or around part (or all) of the handle to assist in the gripping of the handle. Such a sleeve may be particularly useful when the user's hand(s) start to sweat or when the tool is used in wet weather. Such a sleeve may be permanently fitted to the handle, or it could be removeably attachable, for example, it could be adapted to slide over the handle and positioned at a desired place. It is also envisaged that the sleeve may be provided with means for releasably securing it to the handle, for example by the use of ties or buckles or VELCRO® straps.

The gripping means may also include, or be in the form of, a carry handle to assist in the carrying the tool. Such a carrying handle may preferably be releasably attachable to the handle so that it may be attached when the tool is to be carried, and removed when the tool is to be used. The carrying handle may be releasably attached to the handle by any suitable means. For example, the carrying handle may be adapted to slide along the handle of the impact tool and/or be secured by clamps or screws or wing nuts or buckles.

The handle of the impact tool may be made of any material, for example wood, plastic or metal, or a combination of these materials.

Preferably however, the handle may be made from a substantially strong and/or heavy material, for example a metal such as steel. Being made from such a material imparts strength to the tool during use, and furthermore, the significant weight of such a material provides the tool with substantial momentum during use of the tool.

The hollow portion within the handle of the impact tool may preferably be partly or wholly filled, or fillable, with a moveable material, whereby the moveable material (once placed within the hollow portion) is able to move along the hollow portion of the handle during use of the impact tool.

According to another aspect of the present invention, there is provided an impact tool, substantially as described above, wherein the hollow portion extends substantially the entire length of the handle.

One advantage of such an embodiment is so that the maximum amount of momentum can be provided to the moveable material within the handle during use of the impact tool. That is, in general terms, the longer the hollow portion, the higher the velocity the moveable material will be able to attain during use of the impact tool. And the higher the velocity of the moveable material, the more momentum that is ultimately added to the impact tool.

Alternatively, the hollow portion may only extend for a portion of the length of the handle.

According to another aspect of the present invention, there is provided an impact tool, substantially as described above, wherein the moveable material may be housed within a container, the container being housed (or able to be housed) within the hollow portion of the handle, whereby the container is able to move along the hollow portion of the handle during use of the impact tool.

In such an embodiment the container may preferably be provided with a resealable opening such as a bung or screw cap to enable moveable material to be readily added and/or removed from the container.

The hollow portion within the handle of the impact tool may also be accessible, that is provided with means for accessing the hollow portion. For example, an end of the handle of the impact tool may be provided with a releasably attachable end cap or screw cap, or alternatively a resealable opening such as a bung. Having a hollow portion which is accessible may allow for the amount or type of moveable material within the handle (or the container) to be altered, or removed altogether.

Any suitable moveable material may be utilised as required or as desired, or as dictated by the intended use of the impact tool.

According to another aspect of the present invention, there is provided an impact tool, substantially as described above, wherein the moveable material may include a number of objects or particles.

For example, the moveable material may include sand.

Alternatively, or additionally, the moveable material may include a plurality of metal components. Examples include, but are not limited to, lead balls, ball bearings, nuts and bolts or washers.

It is also envisaged that the moveable material may be a liquid such as water, which may be poured into the hollow portion of the handle (or the container). In such an embodiment, the hollow portion within the handle (or the container) may be adapted to be water tight.

According to another aspect of the present invention, there is provided an impact tool, substantially as described above, wherein the moveable material may be a singular object.

For example, the moveable material may be in the form of a metal bar which may be inserted into the hollow portion of the handle.

It may be appreciated that the amount of moveable material housed within the container and/or the hollow portion of the handle may be varied according to how much extra weight, and therefore momentum, may be required or desired. For most impact tools, with a hollow portion extending substantially the length of the handle, it is envisaged that optimum results may be achieved by filling the hollow portion with approximately 10%-70% (by length and/or volume) of moveable material.

Preferably, the moveable material may comprise approximately one third of the length and/or volume of the hollow portion of the handle.

The impact tool may preferably be provided with an impact portion for impacting with a surface or object, with the impact portion being located at one or both ends of the handle of the impact tool.

Preferably, only one impact portion may be provided on any one impact tool, although it is also envisaged that two or more impact portions may be provided. For example, an impact tool may be provided with two impact portions, one at each end of the handle.

The impact portion(s) may be integrally formed with the handle or alternatively it/they may be fitted to the handle, for example by welding or by the use of wedges (similar to how hammer and sledge hammer heads are fitted to their handles).

Preferably, the impact portion of the impact tool may include an impact surface.

The impact surface may be defined as being the part of the impact portion that ordinarily impacts against the surface or object being struck by the impact tool, during normal use and operation of the impact tool.

For example, if the impact tool was a sledge hammer, then the impact surface would be the face of the head of the sledge hammer that strikes against the surface or object being impacted.

Similarly, if the impact tool was a hand held compactor (or ramming device), then the impact surface would be the flat compacting head of the compactor (or ram) used for compacting (or ramming) the ground (or other) surface being struck by the impact tool.

According to another aspect of the present invention, there is provided an impact tool, substantially as described above, wherein the impact surface is substantially perpendicular to the longitudinal axis of the handle and/or direction of movement of the handle, during use.

For example, if the impact tool was a hand held compactor, as described above, then it may be appreciated that the impact surface of the compacting head is substantially perpendicular to the longitudinal axis of the handle and/or direction of movement of the handle, during use (normal movement of the handle during use being upwards and downwards in a substantially vertical plane).

Similarly, a hand held ramming tool would also have an impact surface (namely, the leading edge or surface of the ramming head) substantially perpendicular to the longitudinal axis of the handle and/or direction of movement of the handle, during use.

According to another aspect of the present invention, there is provided an impact tool, substantially as described above, wherein the impact surface includes (or comprises) a cutting surface.

For example, the impact portion may be an axe head, and the impact surface may therefore be in the form of the blade or cutting surface of the axe head. Alternatively, the impact portion may be a log splitting blade, and the impact surface may be the blade or cutting surface of the log splitting blade.

In such embodiments, the arrangement and construction may preferably be such that the axe head or log splitting blade may be attached to the handle whereby the cutting surfaces of the axe head or log splitting blade is/are substantially perpendicular to the longitudinal axis of the handle and/or direction of movement of the handle, during use (normal movement of the handle during use being upwards and downwards in a substantially vertical plane). In such embodiments, it may be appreciated that the impact tool essentially combines the attributes of a spade and an axe (and/or a ram or sledgehammer). Such an impact tool may, for example, expedite the manual digging of holes—and especially in ground with impediments such as tree roots, stones, rocks, concrete, scoria, reinforcing mesh, frozen ground, and the like.

In use, as the impact tool is used to strike against a surface or object, the moveable material within the handle may move along the hollow portion of the handle in the direction of movement of the impact tool (or handle) thus providing the impact tool with extra momentum.

Furthermore, in use, the movable material may be adapted to impact against an end of the hollow portion of the handle, in the region of where the impact portion is located, immediately after impact tool has impacted with the surface or object being struck, whereby the impact tool effectively delivers two impacts to the surface or object being struck, each time the impact tool is used.

For example, in relation to a hand tool such as a sledgehammer, there may be provided a hollow portion within the entirety of the handle of the sledgehammer, and preferably extending from the sledgehammer head to the opposite end of the handle. A moveable material, such as those described previously, may either be placed in the hollow portion directly, or in a container which is then placed in the hollow portion. Preferably, approximately one third of the hollow portion may be occupied by the moveable material.

In use, and as the sledgehammer is impacted against a surface, the leading face of the sledgehammer will hit the surface first, closely followed by the moveable material striking against the end of the hollow portion of the handle. It may be appreciated therefore that there will be two distinct impacts against the surface being struck, separated by a minimal time period (usually less than a second). That is, the first impact is the head of the sledgehammer (and this is the hardest impact), followed almost immediately by a smaller second impact as the moveable material hits the end of the hollow portion of the handle. This second impact adds to the overall amount of momentum that the sledgehammer is able to apply against the surface, thus increasing the overall usefulness and impacting strength of the sledgehammer.

Furthermore, the action of the moveable material within the handle of an impact tool serves to significantly reduce the jarring effect associated with the use of the impact tool. That is, as the impact portion of an impact tool strikes against a surface, there is ordinarily a significant jarring effect experienced by the user. However, in the impact tool of the present invention, the second smaller impact of the moveable material (which immediately follows the main impact of the head of the sledge hammer) serves to significantly dampen this jarring effect.

Moreover, it is found that a significant amount of the jarring force or energy is transferred to the moveable material, rather than to the impact tool or the user. This usually results in the moveable material being forced back along the hollow portion in the opposite direction to the direction of movement of the impact tool during use. Hence, the transference of a significant portion of this jarring energy to the moveable material rather then the tool or the user, effectively reduces the jarring forces associated with normal use of the tool, which minimises discomfort (or the chances of injury) to the user.

According to another embodiment of the present invention there is provided an impact tool, substantially as described above, wherein, in use, the handle of the impact tool is predominantly moved in a substantially vertical plane and/or in an up and down motion.

For example, a compacting tool (or ram) used to compact the soil or ground surface around a fence post would fit this description. Namely, the handle of the impact tool would predominantly be moved in a substantially vertical plane and/or in an up and down motion. That is, the worker would raise the compacting tool upwards and then push it sharply downwards in order to impact the compacting head of the tool with the ground with as much momentum as possible. It is envisaged that the present invention may be particularly suitable for use in such a tool and/or in relation to such a tool motion.

Alternatively and/or additionally, another feature of the present invention is that the impact tool may also be used in a substantially horizontal plane, or indeed any direction in between, and still benefit from the increased momentum provided by the movement of the moveable material within the handle of the impact tool, during use of the tool.

In another embodiment of the present invention, the impact portion of the tool may be releasably attachable to the handle, whereby a number of different impact portions may be attached to the handle and used as or when required or desired. For example, an impact portion in the form of an axe head (with a cutting surface) may be attached to the handle and the tool used to dig a hole and/or cut through ground impediments such as tree roots. Once the hole has been dug, and a post placed into the hole, the axe head may be removed and a compacting head attached to the handle so that the tool may be used to compact the ground or soil around the post.

Any suitable means for releasably attaching different impact portions to the handle may be utilised. Examples include the use of circular clamps, or a bayonet-type fitting (similar to a light bulb bayonet fitting).

In a further embodiment, a different impact portion may be fitted over an existing impact portion. For example, an axe head may be permanently fixed to the handle of the impact tool, and the tool used to dig a hole and/or cut through ground impediments such as tree roots—as described above. Once the hole has been dug, and a post placed into the hole, a compacting head may be releasably attached to the axe head, and the tool used to compact the ground or soil around the post. Any suitable means for releasably attaching different impact portions to an existing impact portion attached to the handle of the tool may be utilised. Examples include some or all of those described previously.

### PREFERRED EMBODIMENTS

The description of a preferred form of the invention to be provided herein, with reference to the accompanying drawings, is given purely by way of example and is not to be taken in any way as limiting the scope or extent of the invention.

### DRAWINGS

FIG. 1: is a front view of one possible embodiment of the present invention,

FIG. 2: is a side view of the embodiment illustrated in FIG. 1,

FIG. 3: is a cut away view of the embodiment show in FIG. 1,

FIG. 4: is a cut away view of a different possible embodiment of the present invention, and

FIG. 5: is a view of a container used for housing a moveable material, as illustrated in FIG. 4.

### DESCRIPTION OF PREFERRED EMBODIMENTS

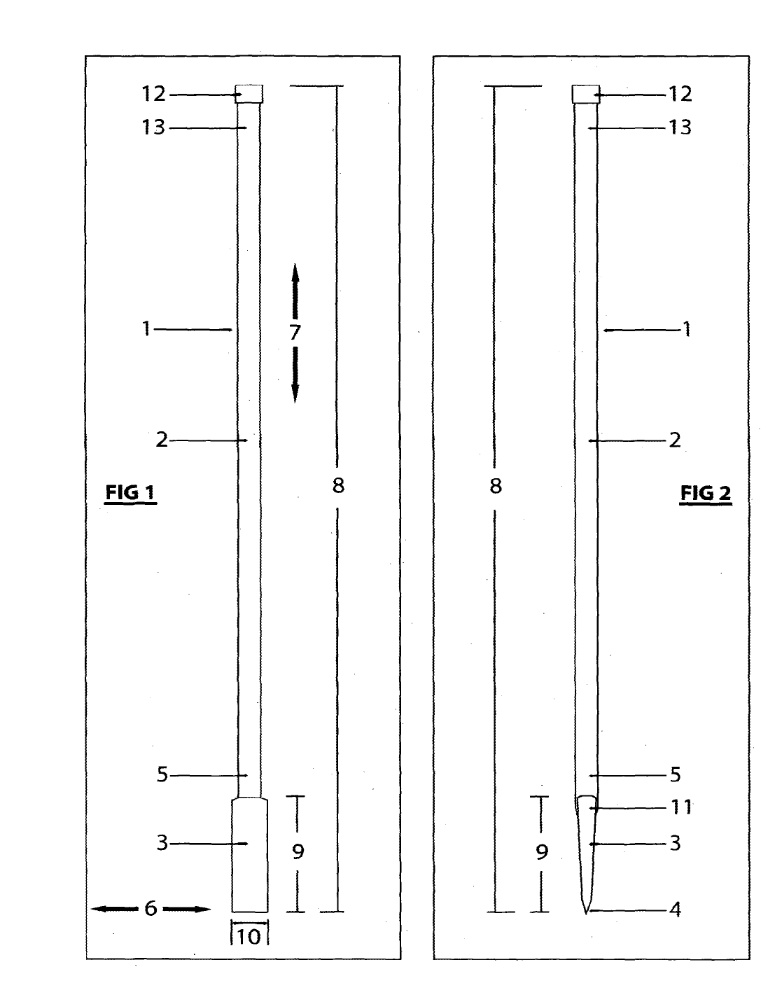

Having regard to FIGS. 1 and 2, there is shown an impact tool generally indicated by arrow 1.

The tool has a handle 2, and an impact portion 3, with a cutting surface 4. The impact portion 3 is fitted to a first end 5 of the handle 2. As can be seen from FIG. 1, the arrangement and construction of the tool 1 is such that the direction of the longitudinal axis 6 of the cutting surface 4 is substantially perpendicular to the direction of the longitudinal axis 7 of the handle 2.

The handle 2 is a circular and hollow steel bar, and is 42 mm in diameter. The impact portion 3 is a log splitting blade. The impact portion 3 is welded to the handle 2.

The second end 13 of the handle 2 has an end cap 12, which presents a rounded, and therefore a comfortable, surface, should the user wish to grip the end 13 of the handle 2 when using the tool 1.

The length 8 of the tool 1 is 1710 mm and the length 9 of the impact portion 3 is 370 mm The width 10 of the impact portion 3 (and cutting surface 4) is 70 mm. The impact portion 3 is 35 mm at its widest point—indicated by arrow 11.

The tool 1 is relatively heavy, given its makeup and constituent parts, and it is therefore a very effective tool for digging and/or cutting and/or demolition work, especially when it is used in a substantially vertical plane as illustrated in FIGS. 1 and 2.

In use, the tool 1 may be raised upwardly and propelled firmly downwards against whatever surface or object it is intended to be used against. The weight and the momentum of the tool 1 is significant and it is therefore a very effective tool for digging holes and/or for cutting through, or smashing up, common impediments or obstacles in the ground such as tree roots, stones, rocks, concrete, scoria, reinforcing mesh, ice or frozen ground, and the like. It is also very effective in digging holes in clay, as it tends to cut through the clay rather than become engulfed in and/or retained by the clay. Moreover, because the tool 1 has a significant length, it is also very useful for leveraging purposes.

The tool 1 essentially combines the attributes of a spade (or trenching spade) with those of an axe and/or a sledgehammer, and it is therefore a very useful and powerful tool to have and to use.

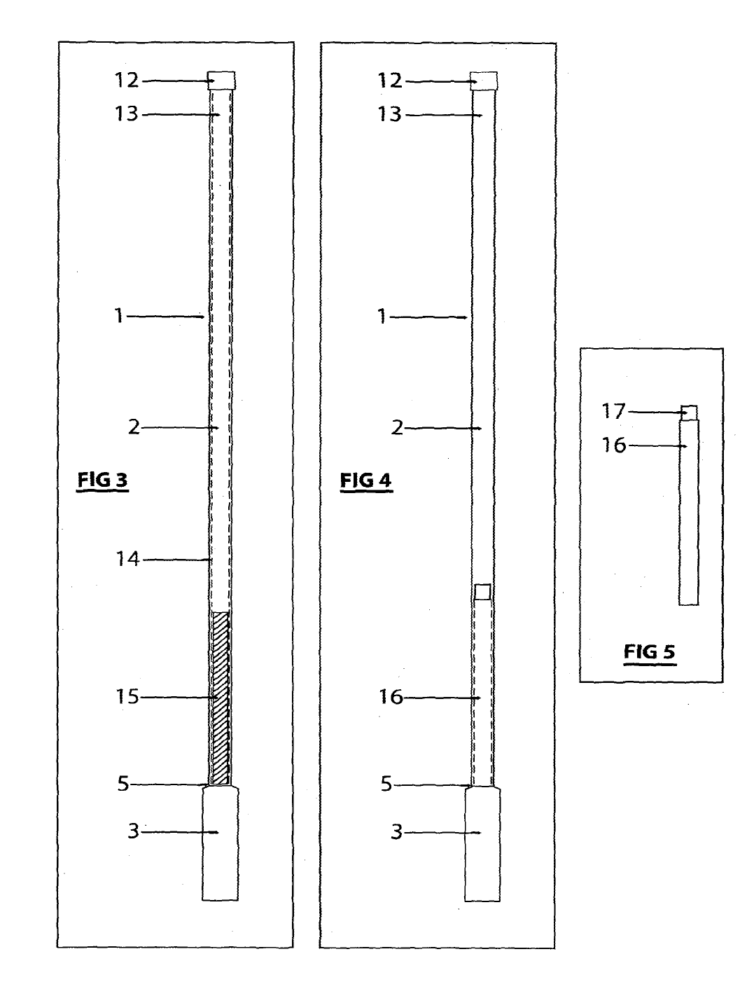

Turning now to FIG. 3, there is shown a cut away view of the embodiment shown in FIG. 1.

As can be seen from FIG. 3, the handle 2 of the tool 1 includes a hollow portion extending its entire length. The end cap 12 is threaded onto an outside thread formed around the second end 13 of the handle 2, and hence the end cap 12 is resealably attachable to the handle 2, whereby the hollow portion of the handle 2 is readily accessible.

Although not shown, the end cap 12 may also be fitted with, or comprise, a particular tool part or accessory. For example, the end cap 12 may be in the form of a spike, and hence the tool 1 could be reversed and the spike used for example to dig into a surface or break up a rock or concrete slab.

Shown in dotted outline in FIG. 3 are the interior walls 14 of the handle 2, thus defining the hollow portion.

The hollow portion of the handle 2 contains a moveable material in the form of a solid steel bar 15. The steel bar 15 is approximately 1 mm less in diameter than the internal diameter 14 of the hollow portion of the handle 2, whereby the steel bar 15 is able to freely move inside and along the hollow portion of the handle 2, during use of the impact tool 1.

The steel bar 15 comprises approximately one third of the length and/or volume of the hollow portion of the handle 2. The steel bar 15 weighs approximately 2 kg and the tool 1 (without the steel bar 15) weighs approximately 9 kg.

In use, as the impact tool 1 is used to strike against a surface or object, the steel bar 15 within the handle 2 may move along the hollow portion of the handle 2 in the direction of movement of the impact tool 1 (or handle 2) thus providing the impact tool 1 with extra momentum.

Furthermore, in use, the steel bar 15 is adapted to impact against the end 5 of the hollow portion of the handle 2 (namely, in the region where the impact portion 3 is located or joined to the handle 2), immediately after the impact tool 1 has impacted with the surface or object being struck. Hence, the impact tool 1 effectively delivers two impacts to the surface or object being struck, each time the impact tool 1 is used.

That is, the first impact is made by the cutting surface 4 of the impact portion 3 and this is the hardest and most powerful impact. This impact is followed almost immediately by the smaller second impact of the steel bar 15 against the end 5 of the handle 2 in the region of the where the impact portion 3 is joined to the handle 2. This second impact adds to the overall amount of momentum that the tool 1 is able to apply against the surface, thus increasing the overall effectiveness and impacting strength of the tool. This is a significant advantage over existing impact tool design and operation.

Furthermore, the action of the steel bar 15 within the handle 2 serves to significantly reduce the jarring effect associated with the use of the tool 1. That is, as the impact portion 3 (and/or cutting surface 4) strikes against a surface, the second smaller impact of the steel bar 15 serves to significantly dampen this jarring effect.

Moreover, it is found that a significant amount of the jarring force or energy is transferred to the steel bar 15, rather than to the tool 1 or the user. This results in the steel bar 15 being forced back along the hollow portion of the handle in the opposite direction to the direction of movement of the impact tool 1 during use. Hence, the transference of a significant portion of this jarring energy to the steel bar 15, rather then the tool 1 or the user, effectively reduces the jarring forces associated with normal use of the tool 1. This is of significant advantage because the reduced jarring effect greatly minimises discomfort (or the chances of injury) to the user during ordinary operation of the tool 1.

In the embodiments shown, the handle 2 of the impact tool 1 would predominantly be moved in a substantially vertical plane and/or in an up and down motion. That is, a user would raise the tool 1 upwards and then push it sharply downwards in order to force the impact portion 3 and/or cutting surface 4 against or into the ground (or obstacle such as tarmac or concrete or ice etc).

Alternatively and/or additionally, another feature of the present invention is that the impact tool 1 may also be used in a substantially horizontal plane, or any direction, and still benefit from the increased momentum provided by the movement of the steel bar 15 within the handle 2 of the tool 2, during use of the tool 2. For example, the tool 1 could be used with the handle 2 in a substantially horizontal plane, in order to knock down a brick wall or fence.

Turning now to FIG. 4, there is shown an alternative embodiment of the tool 1, utilising a different type of moveable material.

In FIG. 4, the hollow portion of the handle 2 is provided with a container 16. The container 16 is hollow and is approximately 1 mm less in diameter than the internal diameter of the handle 2, whereby the container 16 is able to freely move along the hollow portion of the handle 2.

The container 16 is shown in FIG. 5, and it may be seen that it has an internally threaded end cap 17.

In use, the end cap 17 may be removed and the container 16 filled with a moveable material such as sand. The end cap 17 may then be re-attached and the container 16 placed inside the hollow portion of the handle 2, as shown in FIG. 4 (by removing and then replacing the end cap 12 of the handle 2).

The container 16 serves the same function as the steel bar 15 as described previously.

One advantage of the use of the container 16 as compared to the steel bar 15, is that the amount and/or weight and/or type of moveable material placed within the tool 1 may be readily altered. That is, sand may be added or removed from the container 16 as required or desired. Moreover, the sand (or container 16) may be removed and replaced by water or metal components if so required.

In secret trials we compared the results of a first contractor digging a number of holes with conventional tools (spades, axes etc) with a second contractor digging the same number of holes with the tool 1. The quality of the ground surface as regards impediments and the like was essentially the same for both contractors. Our test results indicated that the second contractor completed the digging of his holes, on average, approximately 20%-25% faster than the first contractor. Hence, use of the tool 1 may be advantageous because many fencing contractors quote a fixed price for putting up a fence, and hence the quicker they are able to complete the job, the more cost effective and profitable their business will be and the sooner they can move onto the next job The second contractor also reported less wear and tear on his body than the first contractor.

We believe there are many advantages associated with the use of the tool 1. For example only, some advantages (other than those previously described) of using the tool 1 for digging holes, especially when used by a fencing contractor for such a purpose, include the following:
1. The tool 1 can be used to dig holes of any desired or required size, as compared to a posthole borer that can only dig holes of a size equal to the size of the auger. Hence, holes may be dug of exactly the minimum required size, which means less time and effort and materials is expended in securing the post, eg, by concreting and/or by compacting the ground around the post.
2. The tool 1 is relatively elongate and simple in design and it may therefore readily and easily be carried and/or transported.
3. The tool 1 is much less expensive than a posthole borer. Furthermore, because the tool 1 essentially combines the attributes of a spade, axe and sledgehammer, the contactor may not feel a requirement to purchase these other tools and/or transport them to the job site.
4. The tool 1 is very effective in cutting through impediments such as tree roots and the like. Furthermore, because the impact portion 3 and cutting surface 4 are robust and resilient, there is minimal damage done to the tool when impacting against impediments such as scoria or rock or concrete (as compared to a spade which may easily be damaged when striking such objects). Moreover, the cutting surface 4 of the impact portion 3 may be sharpened from time to time as or when required.
5. There is no requirement for the user to grip the tool 1 firmly as it impacts with the ground, unlike a spade or axe or sledgehammer. That is, the user may grip the tool 1 firmly when raising it, but as it is propelled towards the ground, the user may loosen his/her grip and merely guide it or hold it with “soft hands” and let the significant weight of the tool 1 do the majority of the work.
6 Impediments such as tree roots or rocks are often struck without warning and hence the unexpected jarring associated with striking a tree root can be uncomfortable and painful for the contractor. However, because the tool 1 may be used with “soft hands”, and also because of the dampening effect provided by the moveable material (as well as the increased momentum of the tool 1 provided by the moveable material), the effect on the contractor of any unexpected jarring is minimised.
7. When digging through clay, the tool 1 does not become stuck in the clay and furthermore it can be leveraged to break up the clay or soil within the hole being dug (which may be picked up by a scissor spade). It is also very useful for general leverage purposes, either when digging a hole and/or clearing an impediment in the ground and/or for general leverage purposes unrelated to digging the hole.
8. An axe or a sledgehammer are not usually suitable to use to clear impediments in a hole being dug because they require room to swing them, and the hole may not allow this. In such instances it is common for the contractor to dig a hole next to the one being dug just so that room is provided to swing an axe or sledgehammer. This is time consuming and therefore costly, and furthermore this second hole suddenly becomes a weak point next to the main hole being dug, even when it is filled back in and compacted.

### Variations

While the embodiments described above are currently preferred, it will be appreciated that a wide range of other variations and modifications might also be made within the general spirit and scope of the invention and/or as defined by the appended claims.

We claim:

1. An impact tool for impacting with a ground surface, comprising:
a handle, said handle including a hollow portion;
an impact portion for impacting with the ground surface, said impact portion being located at one or both ends of said handle,
said impact portion including an impact surface, the longitudinal axis of the impact surface being substantially perpendicular to the longitudinal axis of the handle; and
a moveable material housed within said hollow portion of said handle, said moveable material being moveable along said hollow portion of said handle during use of said impact tool,
the arrangement and construction being such that, in use, the handle of the impact tool is predominantly moved in a substantially vertical plane and/or in an up and down motion, and as the impact tool is used to strike against the ground surface, the moveable material moves along the hollow portion of the handle in the direction of movement of the impact tool to provide the impact tool with extra momentum.

2. The impact tool as claimed in claim 1, wherein said hollow portion extends for an entire length of said handle.

3. The impact tool as claimed in claim 1, wherein said moveable material is housed within a container, said container being housed within said hollow portion of said handle and said container being able to move along said hollow portion of said handle during use of said impact tool.

4. The impact tool as claimed in claim 1, wherein said moveable material is a metal bar.

5. The impact tool as claimed in claim 1, wherein said moveable material comprises approximately one third of the length or volume of said hollow portion of said handle.

6. The impact tool as claimed in claim 1, wherein said impact surface includes a cutting surface.

7. The impact tool as claimed in claim 1, wherein said impact portion is a compacting head or a ram.

8. The impact tool as claimed in claim 1, wherein, in use, the movable material is adapted to impact against an end of the hollow portion of the handle, in the region of where the impact portion is located, immediately after the impact tool has impacted with the surface or object being struck, whereby the impact tool effectively delivers two impacts to the surface or object being struck, each time the impact tool is used.

9. The impact tool as claimed in claim 1, wherein said handle is provided with means for accessing said hollow portion.

10. The impact tool as claimed in claim 9, wherein said means includes an end cap, said end cap being releasably attachable to one end of said handle.

11. The impact tool as claimed in claim 1, wherein said impact portion is releasably attachable to said handle.

12. An impact tool, comprising:
a handle extending in a length direction, said handle including a hollow portion provided therein;
an impact portion, located at an end of said handle, for impacting against a target surface; and
a moveable object enclosed within said hollow portion of said handle, an entire length of said moveable object being less than an entire length of said hollow portion in the length direction of the handle,
an interior volume of said hollow portion of said handle being empty except for a portion occupied by said movable object,
said movable object being free to move within an interior of the hollow portion of said handle from a distal end of the interior to an opposite proximate end of the interior, the proximate end corresponding to the end of said handle where said impact portion is located,
the proximate end of the interior of the handle comprising an impact zone for transferring momentum from the moveable object to the impact portion.

13. The impact tool as claimed in claim 12, wherein said moveable object is a container comprising a hollow interior for containing a filler material and an end cap for sealing the filler material within the container.

14. The impact tool as claimed in claim 13, wherein the hollow interior of the container is filled with sand.

15. The impact tool as claimed in claim 12, wherein said handle has a substantially constant cross section.

16. The impact tool as claimed in claim 15, wherein said moveable object is a singular object.

17. The impact tool as claimed in claim 16, wherein a width of said movable object is correspondent to a width of the hollow portion such that the moveable object is free to slide along the length of the interior of the hollow portion inside said handle from the distal end of the interior to the opposite proximate end of the interior.

18. The impact tool as claimed in claim 17, wherein said moveable object has a length in the length direction that is approximately one third of the entire length of the hollow portion of said handle.

19. The impact tool as claimed in claim 18, wherein said moveable object is a metal bar.

20. The impact tool as claimed in claim 18, wherein said moveable object is a container comprising a hollow interior for containing a filler material and an end cap for sealing the filler material within the container.
